(19) United States
(12) Patent Application Publication
(10) Pub. No.: US 2003/0042778 A1
(43) Pub. Date: Mar. 6, 2003

(54) Vehicle seat with inclination adjuster

(75) Inventors: Ingo Teufel, Rockenhausen (DE); Joachim Muhlberger, Obersulzen (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: KEIPER GmbH & Co

(21) Appl. No.: 10/230,480

(22) Filed: Aug. 28, 2002

(30) Foreign Application Priority Data
Sep. 1, 2001 (DE) 101 42 962.2

(51) Int. Cl. B60N 2/02

(52) U.S. Cl. 297/337

(57) ABSTRACT

In a vehicle seat (1), especially a motor vehicle seat, having an inclination adjuster (27, 29) for adjusting the inclination of a seat cushion of the vehicle seat (1) relative to a substructure (5, 7), a height adjuster (11) for adjusting the height of the seat cushion relative to the substructure (5, 7), and a compensating spring (35) which acts on a moving part of the inclination adjuster (27, 29) to compensate at least for the weight of the seat cushion, the compensating spring (35) is coupled to a moveable part (11) of the height adjuster.

### BACKGROUND OF THE INVENTION

The present invention relates to a vehicle seat, especially a motor vehicle seat, with an inclination adjuster.

A vehicle seat with an inclination adjuster is disclosed by DE 199 42 975 C1. This known seat has a seat frame whose front part forms a cross member which carries the front end of a seat shell that accommodates the seat cushion and which, to adjust the inclination of the seat cushion relative to the side parts of the seat frame, can be pivoted about a horizontal axis and, as a result, its height can be changed. In this case, on one side a geared fitting is provided for adjusting the angle of inclination, and on the other side a hinge is provided. In order to compensate for the weight of the seat shell, the seat cushion and the weight of the user, a compensation spring is provided in the area of the hinge, by means of which the cross member is supported on the seat-frame side part.

### BRIEF SUMMARY OF THE INVENTION

One aspect of the present invention is the provision of an improved vehicle seat with an inclination adjuster, in particular the provision of an adaptation of the above-discussed compensation spring which fits the loading.

In accordance with one aspect of the present invention, a vehicle seat includes an inclination adjuster for adjusting the inclination of a seat cushion, with the inclination adjuster including a compensation spring mounted for acting on a movable part of the inclination adjuster to compensate for at least the weight of the seat cushion. In accordance with this aspect, the compensation spring is coupled to a movable part of a height adjuster of the vehicle seat, so that the force applied by the compensation spring to the movable part of the inclination adjuster changes in response to movement of the movable part of the height adjuster.

The fact that the compensation spring is coupled to a moving part of the height adjuster, preferably supported on the latter, means that the prestressing of the compensation spring depends on the height adjustment, and therefore a compensating effect fitting the loading is established. With the height of the seat adjusted to be in a lower position, such as is selected by large and heavy persons, the compensation spring has the greatest possible energy content at any selected desired inclination setting, and therefore the greatest compensating effect. With the height of the seat adjusted to be in an upper position, such as is selected by small and light persons, the prestressing of the compensating spring is lower at the same inclination setting.

In an embodiment which is preferred, can be produced simply and therefore cost-effectively and has a torsion spring as a compensation spring, the spring is arranged between a moveable cross member of the inclination adjuster and a swinging arm (e.g., pivot arm) of the height adjuster.

### BRIEF DESCRIPTION OF THE DRAWINGS

In the following text, the invention is explained in more detail using an exemplary embodiment which is illustrated in the drawings, in which:

FIG. 1 shows a perspective partial view of the structure of the exemplary embodiment in the front region on the tunnel side, and

FIG. 2 shows a schematic side view of a vehicle seat on the sill side.

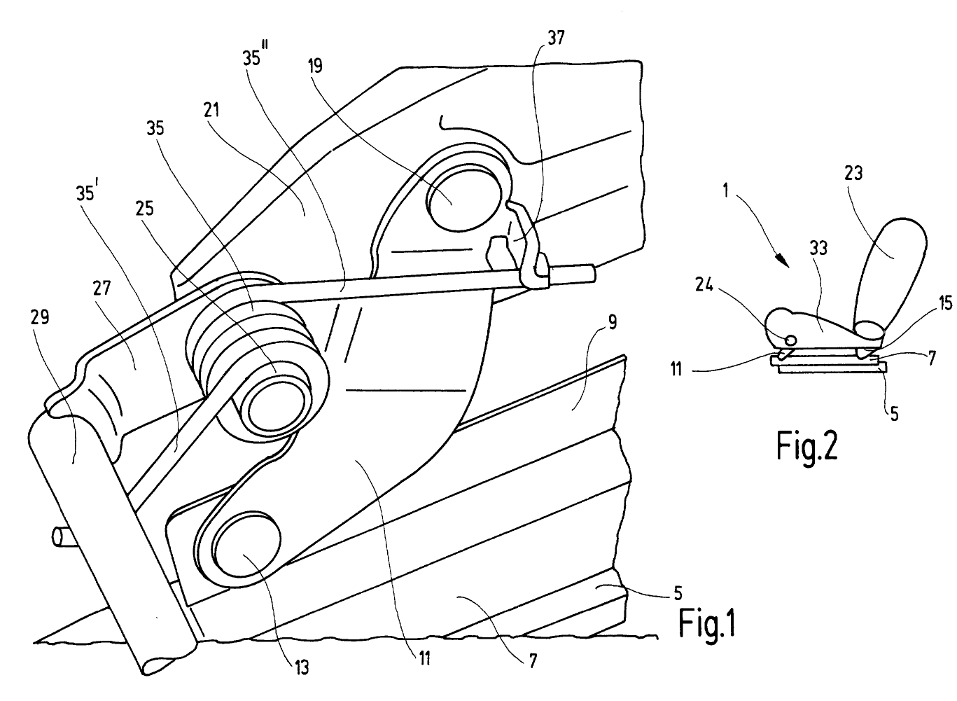

### DETAILED DESCRIPTION OF THE INVENTION

The present invention now will be described more fully hereinafter with reference to the accompanying drawings, in which one or more, but not all embodiments of the invention are shown. Indeed, the invention may be embodied in many different forms and should not be construed as limited to the embodiment(s) set forth herein; rather, these embodiment(s) are provided so that this disclosure will satisfy applicable legal requirements.

A vehicle seat 1 is constructed for a motor vehicle. The arrangement of the vehicle seat 1 in the motor vehicle and its usual direction of travel define the direction statements used below. The vehicle seat 1 has, as a longitudinal adjuster, a pair of seat rails on both its sides, comprising a lower rail 5 fixed to the vehicle structure and an upper rail 7 guided in the lower rail 5 in the longitudinal direction of the vehicle seat 1. The pairs of seat rails form the substructure of the vehicle seat 1. Each upper rail 7 has, at its front end, an adapter 9 which projects upwards and to which a front swinging arm 11 (e.g., pivot arm) is attached by means of a lower bearing pin 13. The front swinging arms 11, together with corresponding rear swinging arms 15 (e.g., pivot arms), form a height adjuster for the vehicle seat 1. The front swinging arms 11 are in each case attached by an upper bearing pin 19 to a seat-frame side part 21 of a seat frame. In its rear region, the seat frame carries a backrest 23 in a manner known per se.

On the seat-frame side part 21 on the sill side, which is located on the outwardly oriented side of the vehicle seat 1, a seat inclination adjusting fitting 24 which points forward is fitted by means of a fixed, first fitting part. From the seat-frame side part 21 on the tunnel side, which is located on the inwardly oriented side of the vehicle seat 1, a hinge pin 25 projects inwards. Pivotably mounted on the hinge pin 25 is an upper swinging arm 27. A cross member 29 arranged horizontally and transversely with respect to the longitudinal direction of the vehicle seat 1 and formed as a tube connects the upper swinging arm 27 permanently to a moveable, second fitting part of the seat inclination adjusting fitting 24. Mounted on the cross member 29 by its front end is a seat shell which, at its rear end, is mounted such that it can move in the rear region of the seat-frame side parts 21 and which carries a seat cushion 33. By means of a pivoting movement of the second fitting part of the seat inclination adjusting fitting 24 and the upper swinging arm 27 which, together with the cross member 29, form the moving parts of a seat inclination adjuster, the height of the front end of the seat shell relative to its rear end, and therefore its inclination, is changed.

In order to compensate for the weight of the seat shell together with seat cushion 33 and, as a result, to relieve the load on the seat inclination adjusting fitting 24, a compensation spring 35 is provided. The compensation spring 35, formed as a torsion spring, is arranged with its central winding on the hinge pin 25, a first leg 35′ projecting forward on the upper side and a second leg 35″ projecting rearward.

The first leg 35′ engages under the cross member 29 and exerts an upward moment. Integrally formed on the front swinging arm 11, in the region of the upper bearing pin 19, is a stop 37 which projects inwards and on whose underside the second leg 35″ rests and is supported, according to the invention. The pretensioning angle between the two legs 35′ and 35″, and therefore the pretensioning of the compensation spring 35, consequently depends on the angle between the upper swinging arm 27 and the front swinging arm 11, that is to say on the height adjustment.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A vehicle seat, comprising:
a height adjuster for adjusting a height of a cushion of the vehicle seat relative to a substructure; and
an inclination adjuster for adjusting an inclination of the seat cushion relative to the substructure, with the inclination adjuster including a compensation spring mounted for providing a force that acts on a movable part of the inclination adjuster to compensate for at least weight of the seat cushion,
wherein the compensation spring is coupled to a movable part of the height adjuster so that said force changes in response to movement of the movable part of the height adjuster.

2. A vehicle seat according to claim 1, wherein the compensation spring is a torsion spring with first and second legs.

3. A vehicle seat according to claim 1, wherein the movable part of the inclination adjuster is a first part of a seat frame, the first part of the seat frame is mounted for moving relative to a second part of the seat frame, and the seat frame at least indirectly carries the seat cushion.

4. A vehicle seat according to claim 2, wherein the movable part of the inclination adjuster comprises a cross member of a seat frame, the cross member is mounted for moving relative to another part of the seat frame, the seat frame at least indirectly carries the seat cushion, and the first leg of the compensation spring acts on the cross member.

5. A vehicle seat according to claim 3, wherein the height adjuster has pivot arms mounted for pivoting in a manner that changes a height of the seat frame relative to the substructure, whereby the height of the cushion is changed.

6. A vehicle seat according to claim 1, wherein the movable part of the height adjuster is a pivot arm mounted for pivoting in a manner that changes the height of the cushion, and the compensation spring is supported on the pivot arm.

7. A vehicle seat according to claim 6, wherein the compensation spring is a torsion spring, and the pivot arm has a laterally integrally molded stop that supports a leg of the compensation spring.

8. A vehicle seat according to claim 2, wherein the moveable part of the inclination adjuster is a first part of a seat frame, the first part of the seat frame is mounted for moving relative to a second part of the seat frame, and the seat frame at least indirectly carries the seat cushion.

9. A vehicle seat according to claim 4, wherein the height adjuster has a plurality of pivot arms mounted for changing the height of the seat frame relative to the substructure by way of pivoting movements, and the movable part of the height adjuster, to which the compensation spring is coupled, is one of the pivot arms.

10. A vehicle seat according to claim 9, wherein the second leg of the compensation spring is supported on said one of the pivot arms.

11. A vehicle seat according to claim 1, wherein the compensation spring is arranged so that said force decreases when the height adjuster is operated to increase the height of the cushion.

12. A vehicle seat, comprising:
a seat frame that at least indirectly carries a seat cushion of the vehicle seat;
a height adjuster including a plurality of pivot arms that are pivotably mounted for changing a height of the seat frame; and
an inclination adjuster for adjusting an inclination of the seat cushion, with the inclination adjuster including a compensation spring mounted for providing a force that acts on a movable part of the inclination adjuster to compensate for at least weight of the seat cushion, wherein:
the moveable part of the inclination adjuster is a first part of the seat frame, the first part of the seat frame is mounted for moving relative to a second part of the seat frame, and
the compensation spring is acted on by at least one of the pivot arms so that said force changes in response to changes in the height of the seat frame.

13. A vehicle seat according to claim 12, wherein the compensation spring is arranged so that said force increases when the height adjuster is operated to decrease the height of the seat frame.

14. A vehicle seat according to claim 12, wherein the compensation spring is a torsion spring with a plurality of legs.

15. A vehicle seat according to claim 14, wherein the first part of the seat frame is a cross member, and a leg of the plurality of legs of the compensation spring acts on the cross member.

16. A vehicle seat according to claim 14, wherein the at least one pivot arm has a laterally integrally molded stop that supports a first leg of the plurality of legs of the compensation spring.

17. A vehicle seat according to claim 16, wherein the first part of the seat frame is a cross member, and a second leg of the plurality of legs of the compensation spring acts on the cross member.
